(19) United States
(12) Patent Application Publication
(10) Pub. No.: US 2005/0086587 A1
(43) Pub. Date: Apr. 21, 2005

(54) System and method for presenting computerized interactive forms to respondents using a client-server-systems technology based on web standards

(76) Inventor: Christopher Mark Balz, Palo Alto, CA (US)

Correspondence Address: dba TreeLogic Software Engineering, 160 Lincoln Avenue, Palo Alto, CA, 94301-2437, US

(21) Appl. No.: 10/438,095

(22) Filed: May 14, 2003

(51) Int. Cl. G06F 15/00

(52) U.S. Cl. 715/505

(57) ABSTRACT

An improved system and method for presenting computerized interactive forms (such as survey questionnaires, employment applications, etc.) via the Internet to human respondents making use of client computers. The invention is a cross-platform web application written in Java and JavaScript. The presented questions/items are selected dynamically as a respondent fills in the information for each question/item. A code-length-reducing software architecture—wherein all objects are widgets—along with a design choice of inheritance makes for maximum code clarity, impressive code compactness, and swift parsing. More information and a higher quality of information are collected from a respondent, because waiting time is reduced and only relevant questions are presented. Implementation of parent-child containment in the widget set, coupled with a JavaScript skeleton design system, facilitates respondent-friendly display design by interface designers, and a rapid design process.

### SUMMARY OF THE INVENTION

The present invention comprises a software architecture and system for presenting interactive forms to a human respondent over the Internet, and acquiring the data that the respondent enters via his or her client computer. These forms may be survey questionnaires; applications for employment, financing, or insurance; registration forms; government or legal forms; and without limitation other forms used for acquisition of information by a centrally-located webserver computer, from a human respondent, submitted via the browser software running on the respondent's client computer.

The invention is novel because it combines the following features:
1) Delegation of control, sequencing, and buffer-storage functions by the central webserver computer to the client computer, wherein they are implemented by a set of codes that are standard and quite ubiquitous on the public and private Internet (namely, JavaScript with the DOM binding and HTML, transmitted via HTTP codes) that have been downloaded from the webserver computer to the client computer. This delegation approach minimizes the bus traffic over the Internet necessary to collect the data from the respondent.
2) An abstract ‘skeleton’ of an interactive form serves as a structure into which a concrete form for any specific purpose may be fitted. This skeleton accommodates a recursive fitting process, in which objects derived from the skeleton may be placed within other objects similar to themselves. This method minimizes the amount of stored code necessary to implement a given interactive form, and also helps to cut down on bus traffic over the Internet.
3) The respondent may alter the form's flow and sequencing interactively, with the alteration process being controlled locally within the client computer. This method further decreases bus traffic, lowers the risk of losing data because of webserver-computer crashes or network traffic disruptions, and reduces the waiting time for the respondent, thereby increasing the likelihood that the respondent will continue with the interactive form-filling-out process until he or she has completed all entries.
4) A flowing approach to the display of each form, avoiding the necessity of absolute x/y-coordinate positioning of form elements, and thereby greatly improving the portability and compatibility of the software across multiple browsers and operating systems.

An embodiment of the present invention provides a method and system for presenting a survey questionnaire on the Internet. The computer-implemented survey questionnaire comprises: obtaining a plurality of survey questions, presenting initial survey questions to a respondent, receiving feedback data from the respondent, and instantly presenting at least one dependent question to the respondent. Other embodiments will be apparent to those skilled in the art.

### FEDERALLY SPONSORED RESEARCH

Not applicable to this invention.

### SEQUENCE LISTING OR PROGRAM

Computer program listing appendix. 2 CD's.

### BACKGROUND

1. Field of Invention

The present invention relates generally to collecting data by means of interactive forms which operate on a human respondent's client computer, wherein they function as satellite processes to a master process operating on a centrally-located webserver computer. The invention comprises a system and method capable of conducting computerized surveys, applications, and other forms; and, moreover, of efficiently presenting interactive-form software to a respondent over the Internet, and storing and forwarding the respondent's answers back to the webserver computer.

The same basic software and communications mechanisms also apply, without limitation, to a very wide variety of usage contexts in which a human respondent fills in information on a survey, application, or registration form, using a personal computer. The invention's effectiveness stems from it having been designed to rely only on those technologies that are most ubiquitously installed on respondent's computers, while achieving specific software performance hitherto unattained with these technologies. Thus, it brings software performance in the handling of interactive forms to the widest possible application area, worldwide, at an unprecedented level of convenience and accessibility.

2. Description of Prior Art

Many organizations, including businesses and government agencies, gather different types of information. In order to improve the services that they render to their customers, organizations gather information ranging from general consumer information and census information to personal medical histories. Traditionally, this information has been gathered by paper-based questionnaires, and then converted to electronic format using data entry. Today, many organizations have begun using online interactive-form systems to further leverage both the traffic coming to their websites and their lists of e-mail addresses of members, potential members, customers, or potential customers—meaning, any respondents who have indicated their willingness to be contacted via e-mail. These organizations are using online interactive-form systems, to upgrade the quality of the information collected, and to reduce the time spent collecting information—which, thereby, improves the timeliness of the information collected.

Although online interactive forms represent a great advance over data entry from manually filled out paper forms, there are two major problems with conventional online interactive-form methods:
1) They result in data of low quality.
2) They are expensive to produce.

These problems stem from the choices conventionally made, for the systems architecture and operational flow of online interactive-form software running over the Internet.

The first problem, data of low quality, results from the slowness and inflexibility of the respondent interactivity provided by conventional online interactive-form methods. This slowness and inflexibility arises, first, because the form appears on a respondent's screen either as a barrage of many questions all presented at once, or else as a series of ongoing screen images redrawn one after another. Both of these techniques cut down on the amount and quality of data collected.

In the former case, all questions, regardless of their level of importance, must be inflexibly presented to the respondent at once. With an interactive form of any significant length, the respondent may well feel that he or she cannot take the time to finish completing the form. The respondent is likely either to skip many questions at random, or to rush through the form too rapidly, simply to get to its end—or even to abandon completing the form altogether.

With the second technique just mentioned, the respondent simply cannot see the end of the interactive form, as the screen is redrawn (and thus changes in its appearance) after each question/item or question/item set, in order to present a new question/item or question/item set. Each time the screen gets redrawn, under this conventional method and system, an entire round trip must be made to the webserver computer that is controlling the administration of the interactive form.

Most Internet respondents do not have extremely high-speed Internet connections. A large majority (about 75%)¹ of Internet respondents rely upon a slower connection such as a dial-up line. And, even respondents who have a nominally high-speed, but shared, broadband connection may experience severe slowing down, when their connections are heavily burdened by streaming music or video downloads by other respondents sharing the same subnetwork. And, in particular, cable high-speed connections may be shared upstream with cable-TV users, in the same geographic neighborhood, who all happen to be watching their televisions at the same time. When a respondent has to wait, for whatever reason, between each redrawn screen display sent out in succession from the central webserver computer, to present the respondent with a new question/item or question/item set, there is a powerful negative psychological inducement to answer questions/items too hastily—or, even to abandon filling out the interactive-form altogether, before finally reaching its end. Moreover, with any type of Internet connection, the appearance of a client-computer's display screen during the transition from one screen display to a completely different screen display will flash alternately between a blank state and a Graphical User Interface (GUI), which disrupts the respondent's concentration and aesthetic experience.

The second problem with conventional interactive-form management methods is that they are costly. With the conventional design, almost no decisions are left to the respondent's client computer; the questions/items on the screen cannot change without a round trip to the central web-server computer. In this approach, HyperText Markup Language (HTML) code is streamed out from the webserver computer to the respondent's computer whenever it is necessary to significantly alter the screen's appearance or contents, such as the questions/items being presented. The rate at which this HTML code can be downloaded typically is enormously slower than the rate at which a contemporary personal computer can make use of the code; hence, this constant HTML-code downloading quite extravagantly wastes the vast computing resources available on virtually every Internet-capable computer today. The HTML code streamed out from the webserver computer is extremely bulky in size, and the string concatenation routines required to generate it on the webserver computer are processor-intensive. Producing and processing this bulky HTML markup code taxes the computing power of the webserver computer(s) supporting the website, and shipping it out to client computers taxes the bandwidth of communications facilities available to these computers. Ultimately, the organization sponsoring the data-collection process must pay for its use of this processing power and communication bandwidth. Thus, unfortunately, the suboptimal software architecture of conventional centrally controlled online interactive-form methods drives up data-gathering costs to the sponsoring organization.

Therefore, there exists a need for an alternate method and system that reduces the amount of processing and communication time required, both to present an interactive form to a respondent via the Internet, and to accumulate data from the respondent. Additionally, there exists a need for an interactive-form-management method and system that reduces the cost to develop specific interactive-form-based software applications that are to be accessed by respondents over the Internet.

### OBJECTS AND ADVANTAGES OF THE PRESENT INVENTION

Accordingly, several objects and advantages of the present invention are:
a) To provide an interactive-form-management program that is less expensive to run.
b) To provide a faster-operating interactive-form-management program that supports collecting more data from respondents.
c) To provide an interactive-form-management program that initially gives a respondent a complete picture of the overall form/questionnaire, by showing the participant a select few of the questions/items that can be fitted onto a small screen.
d) To provide an interactive-form-management program that furnishes a higher quality of collected data, by providing subquestions/items instantly if a respondent indicates interest in a particular containing question/item.
e) To provide an interactive-form-management program that may be structured to allow the respondent to instantly control the direction taken by the interactive form.
f) To provide an interactive-form-management program that will support any desired extensions. An example of a possible future extension, not implemented at the present time, is an interactive-form element that allows the moving of answers around on the screen by dragging-and-dropping them, thereby allowing an interactive-form respondent to weight answers by physically rearranging them into a particular order.
g) To provide an interactive-form-management program, having the advantages recited above, that may be created in a cost-effective manner, and that provides a range of specific design choices integral to the architecture and behavior of the interactive-form-management software provided by the invention. This set of design choices has led to a suite of tools for cost-effectively creating interactive-form-management programs.
   Definitions

Absolutely Positioned Layout=A method by which a browser displays an image on a client computer's display screen, by locating each displayed element at a defined x-y coordinate. See and contrast with flowed layout.

Abstract=A generalized, canonical interactive form definition or interactive-form component, not made specific to any particular object in Object-Oriented Programming (OOP). In the terminology customarily used in the OOP art, an abstract class is the definition of the common elements shared by a group of concrete (i.e., non-abstract) classes. See also concrete.

Application Programming Interface (API)=A collection of computer software code, usually a set of class definitions, that can perform a set of related complex tasks, but has a limited set of controls that may be manipulated by other software-code entities. The set of controls is deliberately limited for the sake of clarity and ease of use, so that programmers do not have to work with the detail contained within the given API itself. The situation is analogous to an airline pilot's control of the speed of an aircraft by moving the throttle control to increase or decrease the aircraft's speed, without having to deal comprehensively with all of the details of how aircraft engines operate and how engines actually effect changes in their power output. See also class definition.

Browser=A complex software program, resident in a client computer, that is capable of loading and displaying text and images and exhibiting behaviors as encoded in HTML (HyperText Markup Language) from over the Internet, and also from the client computer's memory. Major browsers include Microsoft Internet Explorer, several versions of Netscape, Mozilla, and Opera.

Bug, Buggy=A bug is an error in a software program, which causes erroneous or misleading results, and may even cause program crashes. A program with frequently encountered bugs is referred to as ‘buggy.’

Bus Traffic=Messages sent from one part of a computer system to another. In the case of the Internet, the parts of the computer system comprise a client computer (normally used by a human respondent) and a webserver computer.

C++=A programming language developed as an outgrowth of C. At present, C and C++ are the dominant programming languages worldwide. Unlike C, C++ is an Object-Oriented Programming (OOP) language. C++ includes C as a proper subset. C++ in turn heavily influenced the development of Java, a more recent programming language. See also Object-Oriented Programming (OOP) and Java.

Child=In software engineering, a process or an object which is spawned and then launched by some other process or object, which is its parent. A child process/object may have only one parent process/object. See also parent.

Class Definition=In Object-Oriented Programming (OOP), a distinct formation of computer software code that serves as the definition of an object. This definition defines any data, any methods for processing that data, any identifiers, and any other specifics that may belong to an object. Collectively, this definition defines what is termed in the art as a datatype, even though the datatype may include methods for working on data. See also object and Object-Oriented Programming (OOP).

Client Computer=A personal computer (PC), or a workstation computer with all of the capabilities of a PC, which may be connected to the Internet. PCs may range in physical size from desktop units down to notebook/mininotebook units, handheld units, and palmtop units. A respondent operating a client computer may receive and send information over the Internet, including filling out interactive forms. See also webserver computer.

Concrete=An interactive form or interactive-form component which has been made specific to some particular type of Object-Oriented Programming (OOP) object, by extension of an abstract class. In the terminology customarily used in the OOP art, a concrete class is a particular embodiment of a generality defined by an abstract class. See also abstract, class definition, object, and Object-Oriented Programming (OOP).

Constructor=A set of executable code, belonging to a class definition, that directs/orchestrates the creation of a new object from a class definition. See also class definition and object.

CPU=Central Processing Unit, an integrated circuit or group of integrated circuits which executes the program code, within a computing device such as a client computer or a webserver computer.

Data-Centric=Handling and managing dynamically changing information that is input by a respondent or by an outside software program according to customizable software logic. The use of certain data-centric software, that resides and executes on the respondent's client computer and that can manage GRI/GUI elements on the respondent's screen, is essential to client-server software architecture. See also and contrast with webserver-centric; see also Graphical Respondent Interface (GRI) and Graphical User Interface (GUI).

Document Object Model (DOM) Element=An object contained in a Document Object Model (DOM). In the present document, the term DOM is used to refer to the particular DOM held in the memory region being used by the web browser. This DOM directly controls the Graphical Respondent Interface (GRI) or Graphical User Interface (GUI). It is generated according to the information that the web browser reads from the HTML file, and/or from direct JavaScript software instructions. Generally, there exists a unique DOM element for every unique HTML element. Such DOM elements are sometimes referred to as HTML/DOM elements, because often the DOM element exists only because HTML code that was read by the web browser listed some HTML element that had not previously existed, and thereby caused the web browser to create that DOM element. Often specific elements of the greater set of HTML/DOM elements are identified by specifying an ‘HTML/DOM checkbox element,’ or an ‘HTML/DOM text input element,’ and so forth. See also Graphical Respondent Interface (GRI), Graphical User Interface (GUI), and HyperText Markup Language (HTML).

Flowed Layout=A method by which a browser displays an image on the display screen of a client computer, by loading (‘pushing’) the displayed elements into a display file, which in turn is sampled by the display electronics to create and control the displayed image. See also and contrast with absolutely positioned layout.

Graphical Respondent Interface (GRI)=The layout and appearance of the display screen of the human respondent's client computer, including the behavior of the display elements when the respondent enters information into an interactive form.

Graphical User Interface (GUI)=Essentially synonymous with GRI, except that in some contexts a ‘User’ may comprise computing equipment rather than a human being.

HTML/DOM Element=See Document Object Model (DOM) element.

HyperText Markup Language (HTML)=A method of mixing text and other content with layout and appearance commands in a text file, so that a browser can generate a displayed image from this file. HTML code generally does not include software control structures such as loops, jumps and skips, Boolean expressions, and so forth.

Hypertext Transfer Protocol (HTTP)=A set of conventions for controlling the transfer of information via the Internet from a webserver computer to a client computer, and also from a client computer to a webserver.

Inheritance=For an Object-Oriented Programming (OOP) class definition, which may be either abstract or concrete, the derivation of its characteristics and modus operandi from some abstract class definition. Any process may be a parent and spawn an object from a concrete class definition; instantiating the object includes endowing it with the characteristics and modus operandi of the class definition used to instantiate it. Said characteristics and modus operandi include any characteristics and modus operandi that the concrete class definition inherits from any related abstract class definitions. See also class definition, instantiation, and Object-Oriented Programming (OOP).

Instantiation=In Object-Oriented Programming (OOP), the creation of a new object from a concrete class definition, resulting in the allocation of computer memory to the object. At instantiation, the characteristics and modus operandi of any abstract class of the concrete class are factored into the characteristics and modus operandi of the new object. See also abstract, class definition, concrete, inheritance, and Object-Oriented Programming (OOP)

Interactive Form=A sequence of questions or items, presented to a respondent's client computer on its display screen as an image or succession of images, requesting the entry of information by the respondent in a specified format—typing on a line or into a box, clicking on a radio button, checking a small box, etc. An interactive form is not limited to plain text and simple data entry elements (checkboxes, buttons, etc.). Thus an interactive form may contain purely graphical elements, either designed to enhance the user experience (aesthetic and otherwise) or to function as part of the interactive form.

Internet=The worldwide, decentralized totality of webserver computers and data-transmission paths which can supply information to a connected and browser-equipped client computer, and can receive and forward information entered from the client computer.

Java=A programming language, the specifications of which are managed by Sun Microsystems, Palo Alto, Calif. Java as written by programmers resembles C, but when executed by a computer it is converted to ‘Java bytecode,’ a canonical simplified assembly language. Java is used for writing software routines that operate either on an isolated computer, or within a client computer but at the discretion of software residing on the webserver computer to which the client computer is connected by a network such as the Internet. Java is commonly used to handle the software tasks required of a centralized webserver computer. In order to operate on any given web browser on any given computer, Java must be installed on the computer and that installation must be enabled on that web browser. The present invention absolutely does not use Java as the software language of the invention's code that is downloaded to the client computer, because Java is either not installed on and/or is not enabled on the web browsers of most of the client computers that are connected to the Internet. Economic market forces prevent Java from being installed and enabled on most of the client computers that are connected to the Internet. Additionally, security concerns inhibit Java from being installed on a significant number of the client computers that are connected to the Internet. Java-bytecode routines may be executed either interpretively, by byte-mode emulation software running on the CPU within the client computer, or directly, by ‘Java-accelerator’ co-processor hardware within the client computer. See also C++, JavaScript, and webserver computer.

JavaScript=An object-based programming language, not in fact derived from Java, but sharing some common keywords. JavaScript is designed for writing software routines that operate within a client computer on the Internet. In the present invention, these software routines are downloaded to the client computer at the beginning of the interactive session, if they are not already cached on the client computer. JavaScript is so named because common keywords are intentionally shared with Java, in order to facilitate the efforts of software programmers to produce software that runs on the Internet. See also Java, Object-Based Programming (OBP), and Object-Oriented Programming (OOP).

Object=In Object-Oriented Programming (OOP), a collection of code stored in a computer memory, that describes a combination of data and methods that are specifically designed to work upon, transform, and/or process the information. In OOP programming practice, objects are considered to be data, even though they may contain methods in addition to data; hence, objects may contain other objects. See also Object-Based Programming (OBP) and Object-Oriented Programming (OOP).

Object-Based Programming (OBP)=The structuring of software code partly—but not completely—around class definitions. OBP allows the use of objects made from class definitions within code that is not based upon class definitions. See also class definition, object, and Object-Oriented Programming (OOP).

Object-Oriented Programming (OOP)=The structuring of software code completely around class definitions. See also class definition, object, and Object-Based Programming (OBP).

Parent=In software engineering, a process or object which spawns and then launches some other process or object, which is its child. A parent process/object may have many child processes/objects, but a child process/object may have only one parent process/object. See also child.

Platform=The combination of a client computer, an operating system, and a browser, which together can support Internet access and in particular the operation of interactive forms.

Recursion, Recursive=Repeated nesting of software objects or software processes within other objects or processes that are similar to themselves except for nesting level. A simple example would be the nesting of smaller boxes within a large box displayed in an interactive form.

Respondent=A human being operating a client computer, here presumed to be connected to the Internet and running a browser, who is cooperatively supplying information as prompted to do so by an interactive form.

User=A client computer, generally operated by a human being, but in some system contexts running an automated process not under full-time human control.

Web Browser=See browser.

Web Standards=A set of definitions for software languages, encompassing both markup languages and logical languages, maintained by organizations such as the World Wide Web Consortium (W3C), the European Computer Manufacturer's Association (ECMA), the Microsoft Corporation, and the Netscape Corporation. Prominent examples of such standards are HTTP, HTML, DOM, SVG, and ECMAScript. All JavaScript implementations are based upon ECMAScript. Individual private corporations such as Microsoft Corporation, Netscape Corporation, and others maintain a minimal set of common standards that append to the standards defined by the W3C and the ECMA. This minimal set of common standards maintained by individual private corporations exists to ensure the practicality, for software programming efforts, of some of the various languages defined by the W3C and the ECMA. The definitions contained within this minimal set of standards exist as what are known in the art as de facto industry standards, as distinguished from the public standards maintained by the W3C and the ECMA.

Webserver-Centric=Centralized handling of, or holding of, the vast majority of dynamically changing information that is being input by a respondent using a client computer, or by an outside software program within a webserver computer. Updates to the interactive form are forwarded to the respondent's client computer via the network from the webserver computer. The webserver computer also is the repository for information entered by the respondent as it is submitted. See also and contrast with data-centric, as that term is used in this document.

Webserver Computer=A computer able to simultaneously manage many Internet information-exchange processes at the same time. Normally, webserver computers are more powerful than client computers, and are administratively and/or geographically centralized. An interactive-form information-collection process generally is controlled from a webserver computer, to which the sponsor of the process has access. See also client computer.

Widget=An object created by software such as JavaScript, and displayed on or serving to organize the display on the screen of a client computer. Examples of widgets are blank lines for entering text, check boxes, radio buttons, square buttons, sliders that can be moved back and forth by drag-and-drop using a mouse or similar device, top bars, boxes of any size, and drop down lists of selectable items. More complex examples include logical widgets that group their child widgets, and that present themselves on a client-computer display screen only as aggregations of their child widgets.

### PRIOR ART RELATED TO THE PRESENT INVENTION

U.S. Pat. No. 5,986,654, ‘System and method for rendering on-screen iconic buttons with dynamic textual link.’ The Abstract of U.S. Pat. No. 5,986,654 notes that “a subroutine structure can be created in a language called JavaScript that is useful in reducing the amount of program code required to generate multiple display buttons in a single web page.”

The present invention improves upon the system set forth in U.S. Pat. No. 5,986,654 by maturing the concept of such software-code subroutines to the general architecture now standard in the art, Object Oriented Programming (OOP), while retaining the use of JavaScript. The result is a set of what are known in the art as class definitions, which in the present invention are capable of generating, manipulating, and managing many types of GUI or GRI elements described by HTML, and not just display buttons. In fact, these class definitions constitute what is known in the art as a ‘GUI architecture.’ Since these class definitions are written in what is recognized in the art as JavaScript formulated to operate correctly across multiple platforms, the GUI architecture that they comprise can operate on an unprecedented number of computers that are linked to the Internet. The result is a vast improvement in the efficiency of web applications written using this GUI architecture, because of decreased download amounts from the webserver computer to the client computer, because of decreased bus traffic over the Internet, and because of increased data-acquisition reliability—the last, owing to a decrease in data losses occurring because of code-compatibility discrepancies and network disruptions or outages.

U.S. patent application No. 5,956,709, ‘Dynamic data assembling on internet client side.’ In the ‘BRIEF SUMMARY OF THE INVENTION’ section of U.S. Pat. No. 5,956,709, it is noted that “One objective of using the DDAICS method in the Internet applications is to eliminate unnecessary transmissions of useful data by implementing all edit operations, such as adding, deleting, updating, entry check, calculation, and backup on client side in a data assembling process. Also transmissions of useless data will be reduced to minimum if the data checking mechanism is well designed. As a result, the Internet information traffic will be reduced significantly if this method is widely used, and Internet traffic will speed up as a result of reduction of Internet traffic. Also load on servers will be reduced significantly. Overall result is that the scarce Internet resources will be used more effectively and efficiently.”

The present invention improves upon the system set forth in U.S. Pat. No. 5,956,709 by integrating similar data-manipulation and caching techniques with the present invention's structured GUI architecture, as described in the above paragraph. The presentation layer provided by the present invention is clearly and cleanly separated from the business-logic and data-caching functions, providing what is known in the art as the software design principle of ‘effective separation of functionality,’ or more simply ‘modularity.’ Such separation enables the re-use of code, because effective containers for variable functionality can be provided once the basic, necessary, underlying functionality has been defined at its minimum scope by the process of separation. Once the effective containers have been created, they may be simply switched or programmed to exhibit the desired behavior, which accomplishes the re-use of software code, to great advantage. Re-use of software code reduces the amount of new software code needed to create a given software application, greatly lowering the cost of software development; and, moreover, speeding up the performance of web applications written in what are known in the art as interpreted languages, such as JavaScript, as compared with what are known in the art as compiled languages.

U.S. Pat. No. 6,266,681, ‘Method and system for inserting code to conditionally incorporate a user interface component in an HTML document.’ The Abstract of U.S. Pat. No. 6,266,681 states that “A method and system for injecting code into an existing HTML document that enables the conditional generation and incorporation of an injectable component is provided. The injection mechanism provided enables a user to display an add-on user interface component within a web page using a technique that is transparent to the normal processing within a browser application.”

The present invention obviates the need for such an injection, through its capability of creating the entire HyperText Markup Language (HTML) document needed to generate the Graphical Respondent Interface (GRI) or Graphical User Interface (GUI) displayed by the web browser on the client computer screen. The present invention accomplishes this end by providing for reusable code of a sufficiently small time-to-load over the Internet (from two to five seconds) that may itself draw an entire screen consisting of such user-interface elements and other elements directly on the client-computer screen (GUI or GRI) via the client-computer's web browser.

U.S. Pat. No. 6,507,867, ‘Constructing, downloading, and accessing page bundles on a portable client having intermittent network connectivity.’ The Abstract of U.S. Pat. No. 6,507,867 sets forth “A method, system, and computer-readable code for a technique by which multiple Web pages can be dynamically bundled (i.e. packaged) and downloaded for accessing on a user's workstation, enabling the user to perform a meaningful interaction even in the absence of an ongoing network connection. The proposed technique uses an on-demand bundling approach, ensuring that a requesting user will receive the most recent versions of any bundled files. The proposed technique often serves to reduce the number and duration of network connections required, enabling a user to work productively while offline. Further, the bundle may optionally contain executable code such as one or more servlets, which will execute on the user's workstation to enable dynamic content generation. Messages may be created and queued during processing of the downloaded bundle, for sending to a server when the user subsequently establishes a network connection.”

However, in the present invention, it is no longer necessary to download entire web pages to prepare for the next possible screen display (arrangement of GUI elements on the computer's video display screen). Currently, common desktop and portable client computers are able to dynamically display (create, modify) Web pages according to software logic, without needing to maintain a collection of diverse preformulated Web pages, in order to effectively address anticipated needs. The present invention takes the approach of exploiting the computational power of contemporary client computers, resulting in greatly superior performance in terms of speed. Although on many very small computers currently in use, such as some palm-sized computers, the former approach is not yet possible, the state of the art is rapidly ameliorating this situation. The present invention also provides a structure for the placement of software code to control the queuing or resending of messages, in the event of a network disruption or outage.

U.S. patent application 20020035486, ‘Computerized clinical questionnaire with dynamically presented questions.’ In sections [0042], [0052], [0067] of U.S. patent application 20020035486, a system is set forth for providing a limited degree of instant interaction between the software application and the user, where the software application is an interactive questionnaire. The system set forth provides for the customization of questions and control structures; i.e., it is not completely ‘hard-coded’ (constructed of software code bound to a single purpose). However the pressing needs of the software industry obviously extend far beyond simply providing survey-style questionnaires. Therefore, a variable and sophisticated arrangement of reusable graphical user interface elements is required, including variously positioned graphical elements possibly containing buttons, data-input boxes, and so forth. In the present art, that need is being fulfilled by hard-coded single-purpose HTML downloaded to the client, with some extra functionality being included by means of hard-coded single-purpose JavaScript code.

The present invention provides a generalized system, based on re-usable software code, for generating and positioning many of the elements currently provided for by hard-coded single-purpose HTML code and associated hard-coded single-purpose JavaScript code. The present invention offers a system for conveniently and efficiently manipulating HTML code, of a much finer granularity than the system described in U.S. patent application 20020035486—which limits itself to questions for the respondent and their dependencies. In sum, the present invention offers a great deal of flexibility, is quite powerful, is clearly unique, and greatly furthers the art. Furthermore, the present invention integrates into its system the most efficient means to transport data from server to client and from client to server across HTTP (e.g., JavaScript object literal notation). This data-transport task is an essential function of most of the existing sophisticated software on the Internet that collects information from human respondents. The present invention integrates JavaScript object literal notation, not only into the messaging back and forth between the parts of the invention running on the client computer and the webserver computer, but also into the descriptor (skeleton) of the application screen appearance (GUI or GRI) itself, providing added efficiency and flexibility. Furthermore, the coarse granularity of the system provided by U.S. patent application 20020035486 makes it difficult to port the applications built with this system to diverse web browsers, implying that the reach of such applications is limited to respondents who happen to be using the specific web browsers mentioned in U.S. patent application 20020035486.

### DRAWINGS

Drawing Figures

In the drawings, closely related Figures have the same Figure Number but different alphabetic suffixes. These Figures apply to the particular use of the invention for survey questionnaires.

FIG. 1 is a block diagram of a preferred computer system for implementing the present invention.

FIG. 2 is a schematic diagram of a questionnaire formulated according to the present invention.

FIG. 3a illustrates the first window presented to a respondent, upon launching the application of a survey formulated according to a preferred embodiment of the present invention.

FIG. 3b illustrates a page of dependent questions/categories triggered by a respondent's reply to a containing survey question, formulated according to a preferred embodiment of the present invention.

FIG. 3c illustrates a page of further dependent questions/statements triggered by a respondent's reply to a dependent survey question/category, formulated according to a preferred embodiment of the present invention.

FIG. 3d illustrates a page of an additional level of dependent options triggered by a respondent's reply to a dependent survey question/statement, formulated according to a preferred embodiment of the present invention.

FIG. 4a is a block diagram of the initialization cycle of the present invention.

FIG. 4b is a block diagram of the respondent-interaction phase of the present invention.

FIG. 4c is a flow diagram of the data-submitting phase of the present invention.

FIG. 5a is a block diagram of the code-length-reducing software architecture of the present invention.

FIG. 5b is a block diagram of an object directory-tree structure, from the skeleton object of the present invention.

FIG. 6 is a block diagram of the cross-platform rendering scheme of the present invention.

FIG. 7 is a flow diagram illustrating the efficiency of designing the structure and content of an application using the present invention.

FIG. 8 illustrates the code-saving set architecture for rendering multiple widgets in the present invention.

FIG. 9 is a flow diagram illustrating the implementation of class inheritance, such as that of Java or of C++, in JavaScript.

FIG. 10 is a flow diagram illustrating prototype inheritance as implemented in the present invention.

### REFERENCE NUMERALS IN DRAWINGS

20=hardware configuration
22=respondent
24=web browser
26=webserver computer
28=database
30=mainframe computer
32=survey questionnaire
34a=containing question/statement
34b=containing question/statement
36a-g=dependent questions/categories
38a=dependent question/statement
38b=dependent question/statement
40=dependent options
42=respondent interface
45=API
46=controller object
46a=CtController
46b=Controller.js
48=skeleton object
48a=Skeleton.js
50=model
52=widgets
52a=a widget with one child widget
52b=a widget with no child widgets
52c=a widget with two child widgets
52d=a widget with three child widgets
52e=a widget with three layers of nesting
52f=a widget with one child widget distinct from widget 52a
52g=a widget checkbox
54=updates from widgets
56=input from respondent
58=data/a form from respondent
60=a concrete widget
62=a reference to the parent widget
64=a reference to the child widget
66=various concrete properties & methods
68=inheritance
70=abstract widget class
72=the method, ‘getHTML’
74=represents recursion
76=the method, ‘getChildrensHTML’
78=many other properties & methods
80=a tree of widgets
82=parent object
84=child object
86=child object
88=child object
90=child object
92=child object
94=child object
96=child object
98=child object
100=browser frame
102=any non-data-centric non-dynamic widgets (TopBar, for example)
104=a single HTML container widget named ‘Primitive Refresh’
106=non-data-centric dynamic widgets
108=a single HTML form container object
110=data-centric dynamic widgets, and any other widgets
112=GUI API
114=a design ?of what
116=web application front-end
118=non-aggregating approach
120=a set factory
122=set of multiple widgets
124=widget checkbox set
126=A_ConcreteClass
126a=this.superC( );
128=AnAbstractClass
128a=AnAbstractClass_superConstructor
128c=this.anObject=newObject( );
130=A_ConcreteClass.prototype=new AnAbstractClass( );
132=Primitives
134=Objects
150=AbstractWgtWidget
150a=WgtPanel
150b=WgtForm
150c=WgtTopBar
150d=WgtText
150e=WgtLogical
152=AbstractWgtTable
152a=WgtTable
154=AbstractWgtSet
154a=WgtRadioSet
154b=WgtTextAreaSet
154c=WgtSelectSet
154d=WgtTextInput
154e=WgtButtonSet

### DETAILED DESCRIPTION

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

The present invention provides a computer-assisted process for gathering information via the Internet from a human respondent operating a client computer. The invention is a cross-platform web application written in Java and JavaScript code. The presented questions/items are selected dynamically, as the respondent fills in the information for questions/items, without the necessity of a trip to a webserver computer in order to update the client-computer display screen. In contrast to standard computer-assisted interactive-forms, which require a trip to the webserver computer whenever the display screen is to be significantly changed, an interactive form according to the present invention unfolds instantaneously as a respondent fills in the requested information. Collected information is stored in a database within the webserver computer, and secure access is provided for the interactive-form owner or sponsoring organization to information and to analyses of information.

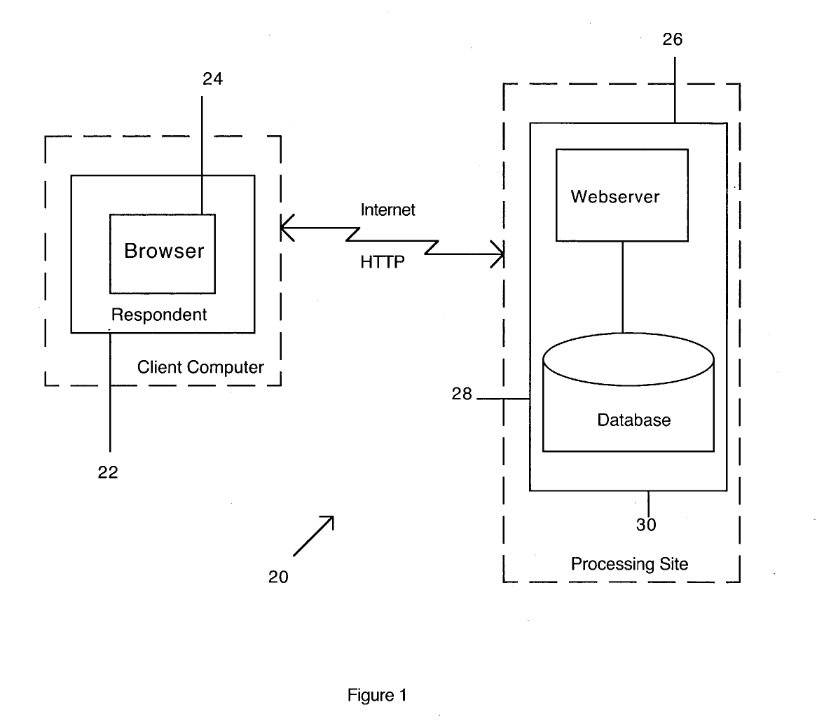

FIG. 1 illustrates the invention implemented in a hardware configuration 20 in which questions/items and response data are transmitted over the Internet. A respondent's client computer 22 contains a web browser 24 and communicates with a webserver computer 26 using a transfer protocol such as HTTP (HyperText Transfer Protocol). The webserver computer 26 and database 28 can be hosted on a single computer of sufficient computational and storage capacity 30. The client computer 22 can be a workstation, laptop, handheld device, or any other device capable of accessing the Internet via the standard HyperText Transfer Protocol (HTTP) through conventional wired or wireless means.

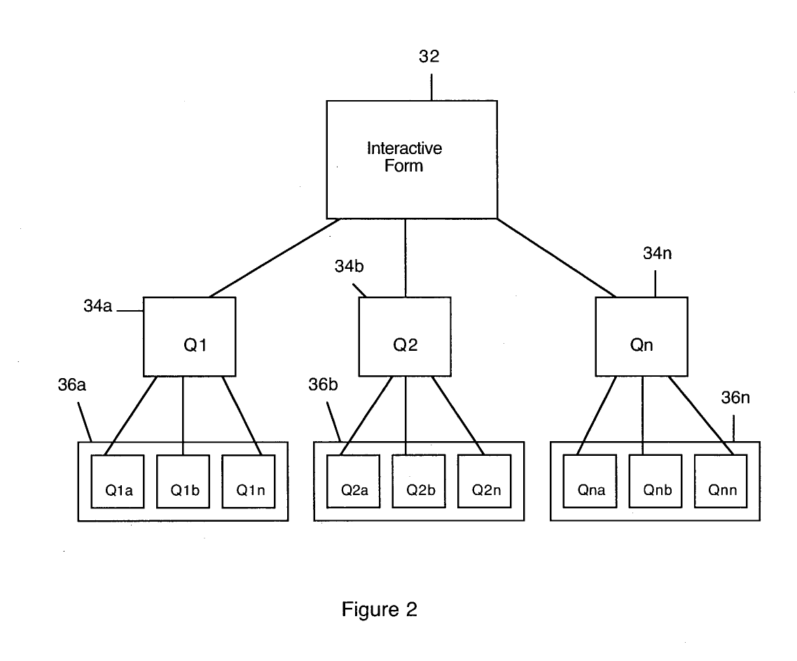

FIG. 2 illustrates the simplest form of how the present invention works for a survey questionnaire. Although the description is for a survey questionnaire, the invention operates similarly for any other type of interactive form handled via the Internet. The web browser 24 renders the interactive form 32 on the display screen of the respondent's client computer 22. Initial/containing questions 34a, 34b, and 34n are presented to the respondent 22. Dependent questions/subquestions 36a, 36b, and 36n are triggered by a respondent's 22 completion of answers to the initial questions 34a, 34b, or 34n. No trip to the webserver computer 26 is required. It is possible within the scope of the invention to have any number of questions and dependent questions, and for dependent questions to have their own dependent questions, and—for the entirety or part of the screen (GRI)—for rearrangements to be executed in response to respondent input, and which comprise not only the display or hiding of child questions.

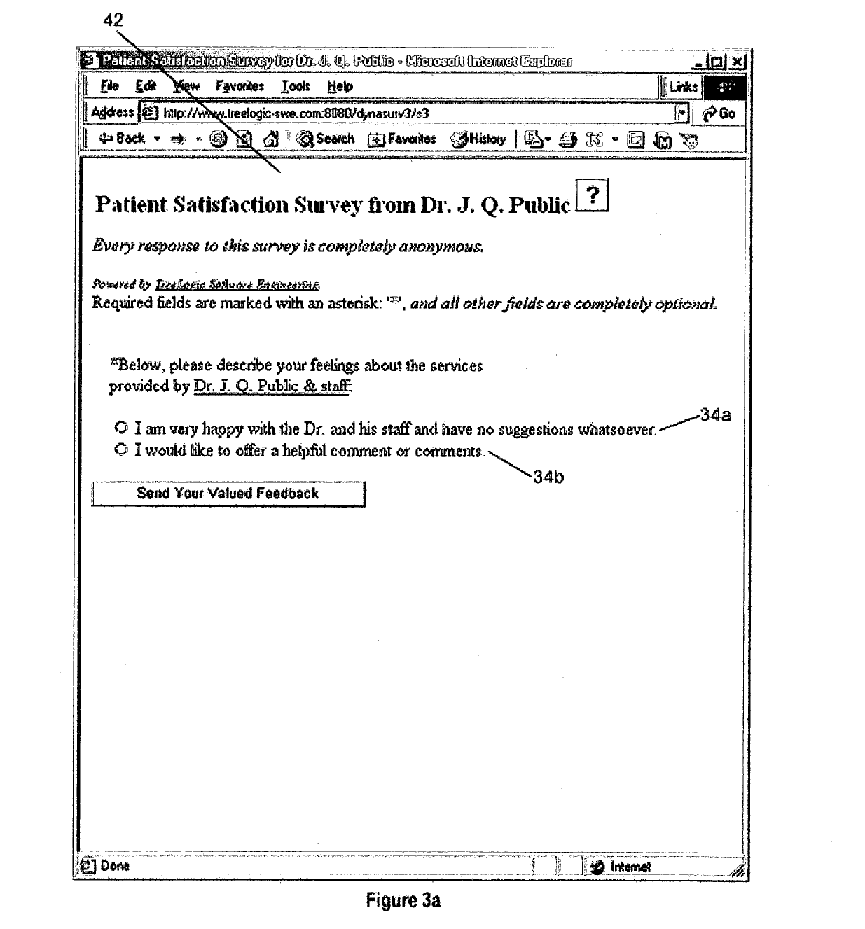

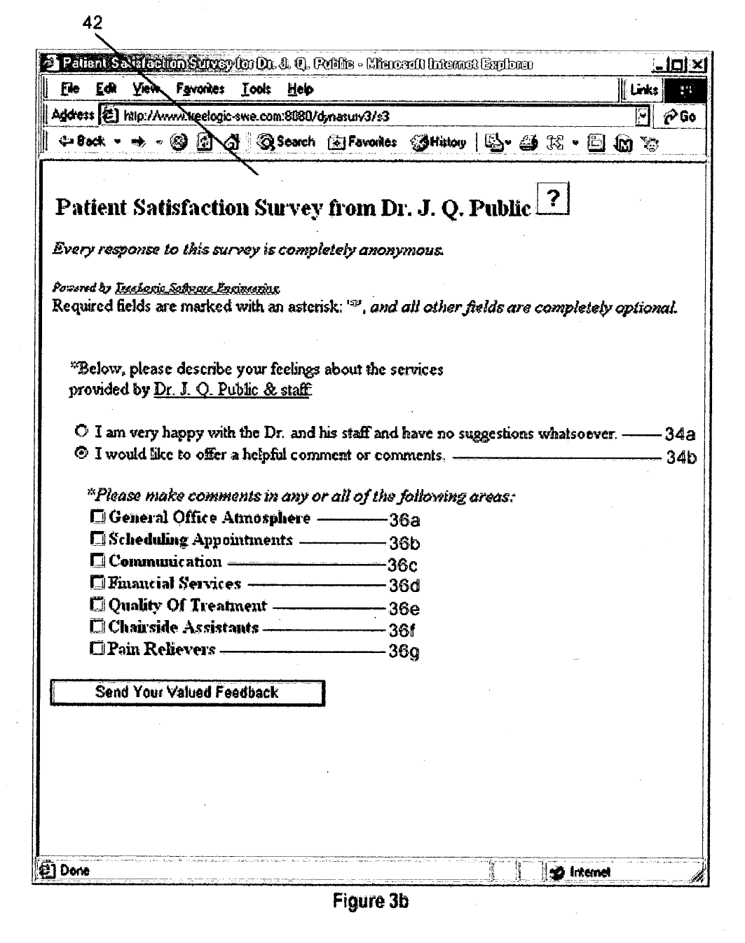

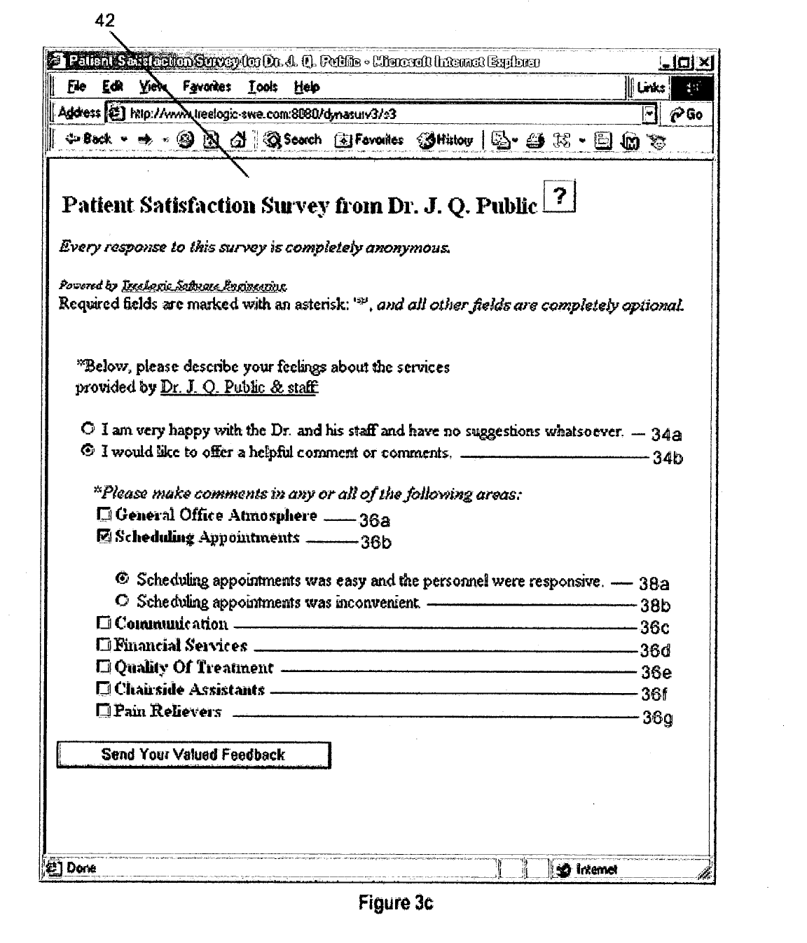

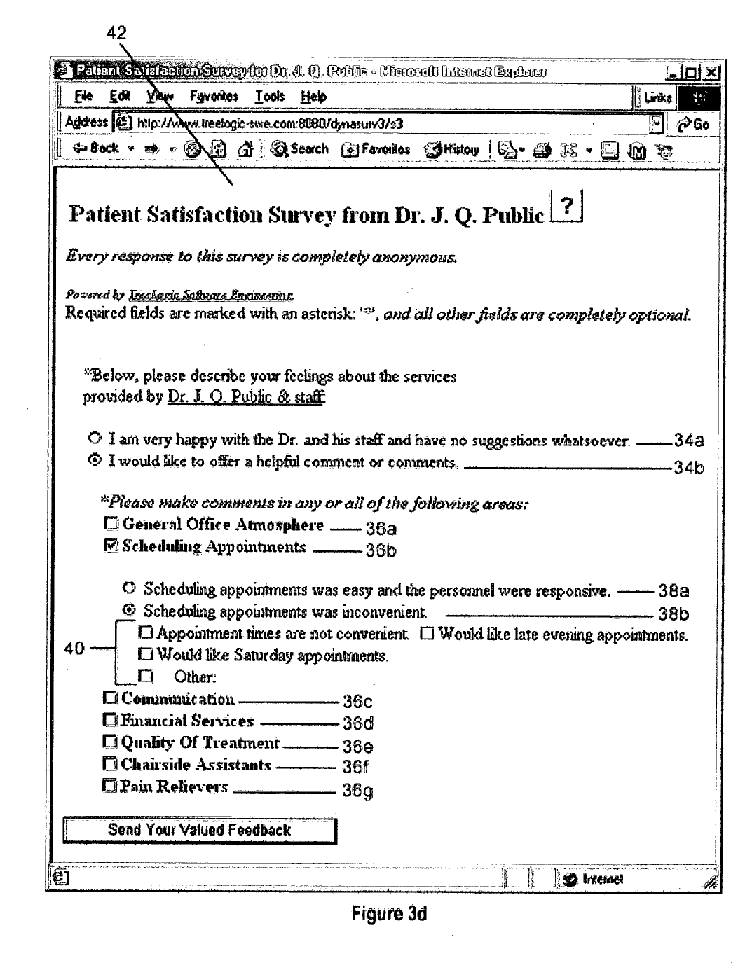

FIG. 3a shows a respondent interface 42 upon launching the application of a survey questionnaire according to the present invention, in which three initial questions/statements 34a and 34b are presented.

FIG. 3b shows a respondent interface 42, where the respondent 22 has triggered the dependent questions/categories 36a to 36g of the initial question/statement 34b.

FIG. 3c shows a respondent interface 42, where the respondent 22 has triggered the dependent questions/statements 38a and 38b of the dependent category 36b.

FIG. 3d shows a respondent interface 42, where the respondent 22 has triggered the dependent options 40 of the dependent statement 38b. FIG. 3d illustrates that there can be several layers of dependent questions, statements, categories and options that instantly appear on the computer screen as a respondent triggers various containing questions/statements. The dependent questions being shown, the parent questions being shown, and even the contents of the entire screen may be changed partially or completely, if such behavior were to be called for by the interactive form in question.

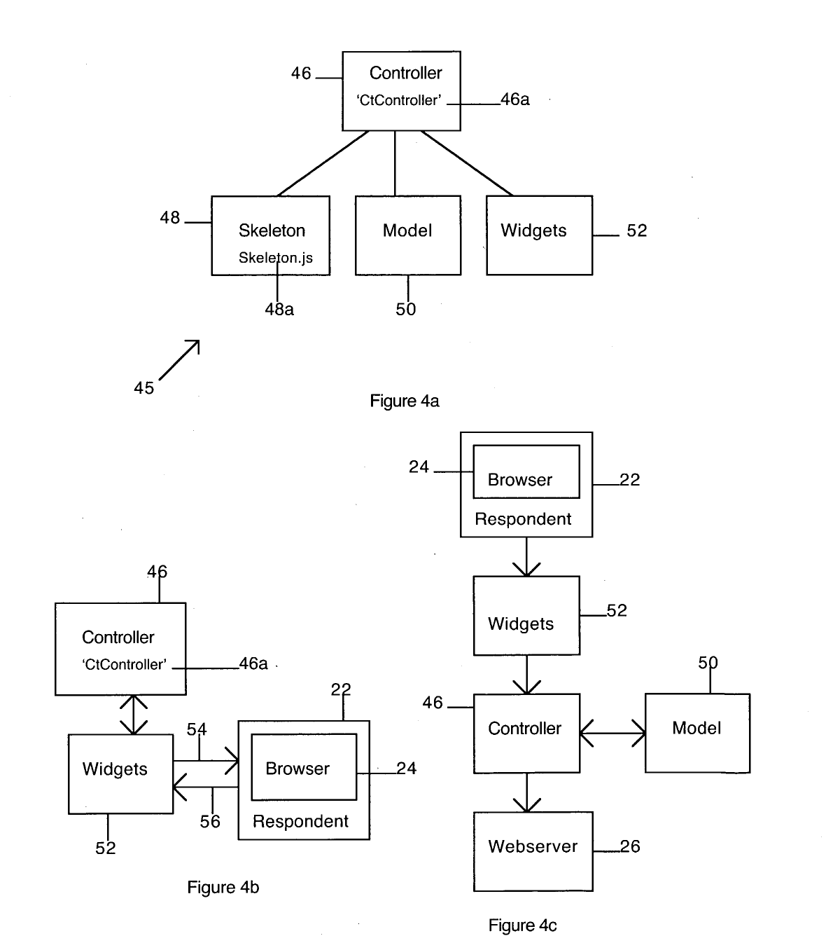

FIGS. 4a-4c illustrate three phases of the execution of the front-end 45 (front-end meaning, executing on the client computer) Application Programming Interface (API) software code provided by the invention on the client computer, and of the associated front-end custom code that defines the specific embodiment. The three figures illustrate what is known to those skilled in the art as an implementation of a software architecture. This software architecture is implemented in what is known to those skilled in the art as JavaScript logic.

FIG. 4a illustrates an initialization phase of the present invention wherein an interactive form API 45 is a set of what is known in the art as JavaScript objects. A Controller object 46 is the starting point for all execution of the interactive form on the browser 24. The Controller object 46 controls exactly what behavior the interactive form will display as it runs on the browser 24. The Controller object 46 first reads a static data structure/skeleton object 48. The Skeleton object 48 controls the appearance of the interactive form on the browser and defines what data validation routines will be applied to respondent input. The Skeleton system is part of the Application Programming Interface or API 45 provided by the invention. The skeleton system operates by a detailed set of rules that, when applied to a specific interactive form implementation, use a Skeleton object to define and set forth an appearance and structure of the interactive form as it appears to the respondent 22 on his or her client computer's display screen as rendered by the web browser 24. The ‘Skeleton.js’ file 48a contains this definition, and sets forth the particular appearance and structure of a given interactive form. The detailed set of rules for interpreting the definition are actually embedded in the code of the Controller and Widget objects, and are described in the product documentation under the heading ‘Designing with the DynaSurv API.’ While the Skeleton object provides an initial definition of interactive-form appearance and behavior, the Controller object actually has final control of the behavior of the interactive-form application/program, and may if so programmed override or adjust this initial definition at any point in the operation of the interactive-form program.

The Controller object 46 then creates a Model/Model object 50 and informs it of the data validation requirements set forth in the Skeleton object 48. The Controller object 46 then creates a widget/view system 52 according to the declarations and settings in the Skeleton object 48. Widgets 52 can be what is known in the art as a top bar, one or more check boxes, one or more text-input boxes, and so on. Widgets 52 will be explained in greater detail below.

Accordingly, the ‘Skeleton.js’ file 48a contains a single JavaScript object definition, the Skeleton object 48. This JavaScript object, named ‘System.objSkeleton’, is defined using what is known in the art as the JavaScript Object Literal Notation or syntax/JSON. JSON offers an extremely compact yet extremely clear way to define what widgets 52 appear where. This definition includes any nesting hierarchies. The Skeleton object 48, therefore, allows for the software code that defines interactive forms such as survey questionnaires to have a short format. The widgets 52 allow for an infinite variety of forms because they can be placed anywhere, including inside one another. The capability of widgets 52, being able to be placed anywhere and inside one another, will be explained in detail below.

Further in FIG. 4a the Model 50 handles the execution of all data validation routines assigned by the Skeleton object 48 to particular widgets 52. It also defines all standard validation routines that may be assigned to a widget.

As stated above, the Controller object 46 has final control over exactly what behavior the interactive form, in this example a survey, will display as it runs on the browser 24. This includes the appearance or non-appearance and placement of widgets 52, and the reaction of the survey questionnaire to respondent input into the widgets. The class definition for the Controller object 46 for any particular interactive form application always extends—i.e., inherits from—the class definition ‘CtController’ 46a. Objects defined by ‘CtController’ 46a, referred to in the art as ‘Objects of type ‘CtController’,’ notice any events that happen during the completion of an interactive form. An example of an event is a mouse click by the respondent 22. Objects of type ‘CtController’ can act on any events if so programmed, and can manipulate widgets 52 to respond in any way desired, thus allowing for an infinite variability in the behavior of the interactive forms.

FIG. 4b illustrates a respondent-interaction phase of the present invention after the initialization phase of FIG. 4a has taken place. Widgets 52 display visible and audible (and/or perhaps, in the future, tactile and olfactory) content on the browser 24 of the respondent 22. Widgets 52 also receive input 56 and update 54 what the respondent 22 sees and/or hears (and perhaps, in the future, feels and/or smells). Additionally, widgets 52 notify the Controller 46 of any input 56 from the respondent 22.

FIG. 4c illustrates a data-submitting phase of the present invention, wherein the widgets 52 sense interactive-form information now available from the respondent 22 via his or her client-computer browser 24, and alert the Controller 46 for review. The Controller 46 checks with the Model 50 to validate certain pieces of data, for example the name and the e-mail address, before sending on the interactive-form information to the webserver computer 26. Of course, if so programmed, the Controller may for example use functionality provided by the Model object to check user input just at the point(s) in time that it is made, and not only upon submission of the entire form to the webserver computer.

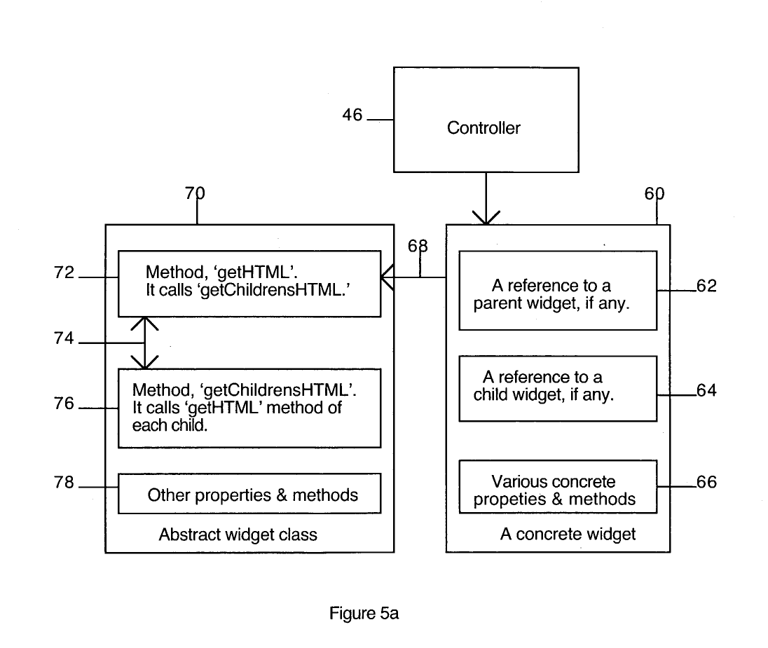

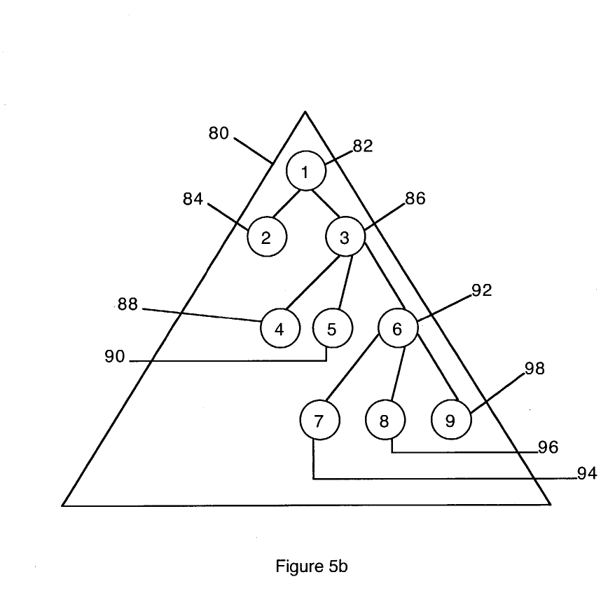

FIG. 5a illustrates a code-length-reducing software architecture of the present invention wherein all objects are widgets. The Controller 46 creates a concrete widget 60, and directs said widget 60 to draw itself using its ‘getHTML’ method 72. Many object properties and object methods used by said widget in this process and in others are defined in the abstract Widget class definition, from which all widgets inherit. This design choice of inheritance 68 makes for maximum code clarity (readability by software engineers), impressive code compactness, and swift parsing and interpretation of the JavaScript code by the computer.

Further in FIG. 5a the concrete widget 60 contains a reference to a parent widget 62, if any, and also a reference to a child widget 64, if any. The concrete widget 60 also contains various concrete properties and methods 66. For example, the concrete widget 60 could be a top-bar widget that contains properties and methods 66 that enable the top bar to show up on the browser screen. A further example of properties and methods would be properties and methods that would enable the top bar to show a help window.

Each widget may have none or more child widgets. References to the parent widget 62 and the child widget 64 maintain a tree structure of widgets illustrated in FIG. 5b.

Additionally in FIG. 5a an abstract widget class 70 defines the minimal functionality for a method ‘getHTML’ 72, and for a method ‘getChildrensHTML’ 76. The method ‘getHTML’ 72 is programmed to invoke a ‘getChildrensHTML’ 76 which in turn invokes the ‘getHTML’ method of each child widget; whereupon each ‘getHTML’ method of a given widget invokes the ‘getChildrensHTML’ method of each child widget of the given widget, and so on, forming what is recognized to those skilled in the art as a recursive control structure or recursion 74. The abstract widget class 70 also contains many other properties and methods 78. The recursive logic/recursion 74 embedded in the abstract widget class 70 is diagrammed in the method ‘getHTML’ 72 and the method ‘getChildrensHTML’ 76.

The result of the execution of the software along this recursive control structure is the entirety of the HTML needed to define the displayed presentation of a given widget and its children. This display may fill the entire screen of the client computer, or it may affect only one restricted smaller portion of the screen. The containment hierarchies provide what is known in the art as a Graphical Respondent Interface (GRI); see also Graphical User Interface (GUI).

The GRI definition is compactly implemented. All containment hierarchies within the present invention are specified by the parent-child relationship of all widgets; parents contain children, which may in turn contain their own children. This containment-hierarchy method is implemented using a very small amount of code, as the hierarchies may be directly encoded in a JavaScript object literal, by means of the present system in the Skeletonjs file as described above. The alternative nonrecursive software architectural solution would require building, referencing, and maintaining a data structure outside of the widgets themselves, in order to determine which widgets to render inside of which other widgets; the result would be excess code.

FIG. 5b, a block representation of a replicated tree structure of widgets from the Skeleton object 48, is shown generally at 80. A tree structure is a visual representation of the relationships between multiple objects within a software architecture. Tree 80 has representations of nine objects. A top-level object or parent widget 82 is represented by a ‘1’ in a circle. The other eight objects are similarly represented by corresponding integers. A second object 84 is a child of the first object, as is a third object 86. The third object 86 is simultaneously a child of object 82 and a parent having the three children, 88, 90, and 92. Object 92 as a parent object also has three child objects 94, 96, and 98. It is possible within the scope of the invention for Object 92 to have none, one, or any number of child objects. The same holds true for any objects in the diagram.

The diagram is but one example of what may occur within the scope of the invention. To further describe FIG. 5b, as an example, Object 92 could represent a parent widget checkbox with Object 98 representing a child widget of a checkbox. The parent widget checkbox Object 92 would be attached to a containing question, and the child widget checkbox Object 98 would be attached to a dependent question.

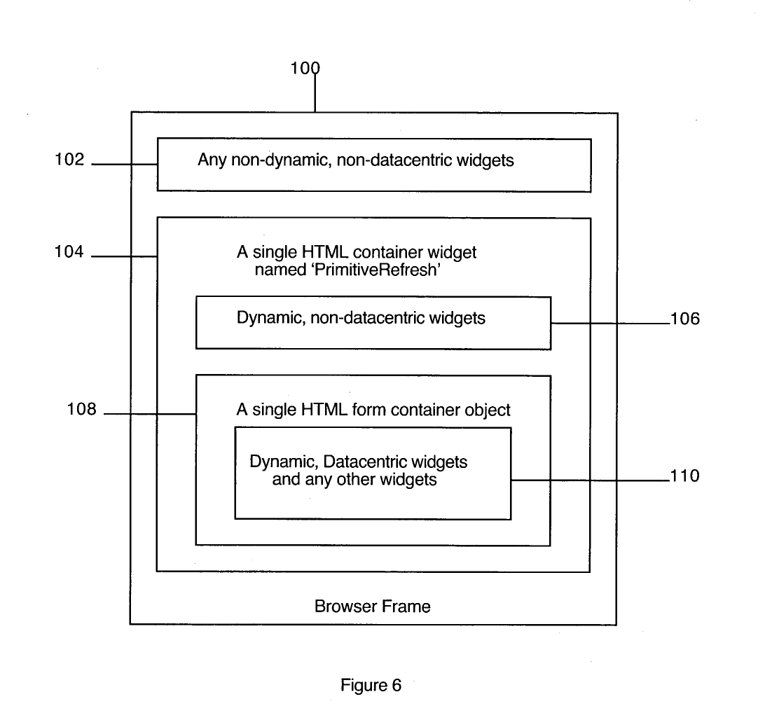

FIG. 6 illustrates a cross-platform rendering scheme of the present invention wherein a browser frame 100 contains any type of non-dynamic non-data-centric widgets 102; for example, a top bar. Additionally, the browser frame 100 contains a single HTML container widget named ‘PrimitiveRefresh’ 104, which itself contains non-dynamic data-centric widgets 108, here meaning ‘widget objects’—for example, a form widget object. The form widget object manages the HTML form element. ‘Manages’ here means that the form widget object yields the appropriate HTML code for defining the form container object's place in the HTML structure, that the form widget object is notified of any respondent-initiated events that occur to the form container object, and that the form widget object controls the data and settings relevant to the HTML form container object. The HTML structure is directly read by the browser, and it informs the browser of what to display on the client computer's display screen, and how to handle certain kinds of data grouped into a single form container object. The single HTML form-container object 108 contains dynamic data-centric widgets, for example a radio button, and also any other widgets 110. Since none of the elements of this display are positioned according to absolute x-y coordinates specified by the programmer of the interactive form, this rendering scheme is what is known in the art as a flowed layout.

That the rendering scheme is a flowed layout is critical, in making the present invention run across many different platforms. The flowed-layout technique dates from the design of the very earliest web browsers, and is less buggy than absolutely positioned layouts. The rendering scheme locates all dynamic data-centric widgets inside a single form widget, but is itself located inside a single refreshable container (‘PrimitiveRefresh’ 104); this architecture is equally critical to enabling the present invention to run across many different platforms.

FIGS. 4a through 6 illustrate the client-side functionality of the present invention. Rather than streaming HTML out from the webserver computer, the present invention composes HTML locally within the respondent's client computer. This local composition means that:
1) Since almost no HTML is composed on and transmitted from the webserver computer, computational load is greatly reduced.
2) Network load is greatly reduced, since verbose HTML markup is not being sent to the client.
3) The interaction experience for the respondent is greatly speeded up, and application-hosting costs are reduced.

Use of the code-length-reducing architecture of the present invention, combined with the nesting hierarchies of the widget system, supports an efficient and respondent-friendly interactive-form implementation. The initial downloading time of the interactive form is reduced, because of the small size of the software code. The waiting time between input by the respondent and updates on the screen is reduced, because dependent questions/items are presented instantaneously, without having to allow the time for a round trip to the webserver computer and for the screen to be redrawn. The invention is operative on 99.5% of all installed web browsers, according to recent field tests and current industry trends. This broad-based operational compatibility has been possible because the invention is formulated to use only software defined by web standards, because its rendering scheme is a flowed layout, and because it locates dynamic data-centric widgets within a specific HTML structure. (See ‘PrimitiveRefresh’ above.) Also, this broad-based operational compatibility has been possible because numerous explicit workarounds have been included within the program code, in order to avoid known bugs in various browsers. Almost all of these workarounds have been localized, for clarity and ease of maintenance of the software code, into a single class.

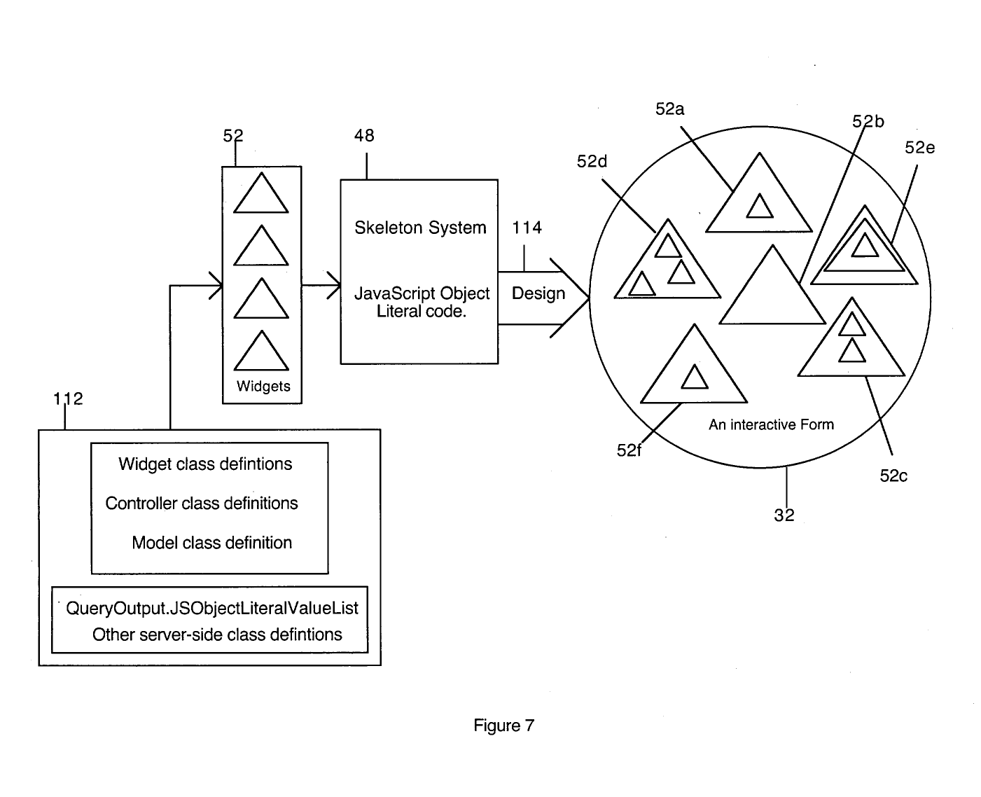

FIG. 7 illustrates the efficiency of the process provided by the invention for designing the content of an application by a team of human software programmers and/or web designers, using a Graphical Respondent Interface (GRI), and Widget and Controller objects provided by the Application Programming Interface (API) 112 of the present invention. Regarding the functionality of an application that is resident on a server computer (as opposed to the client computer), the present invention may easily be used with the industry-standard reference implementation of the Java servlet API specification. In the drawing, widgets 52 are represented by triangles. Widgets 52 may be graphical elements such as the web application heading bar for the top of the browser/top bar, radio buttons, square buttons, check boxes, and text input boxes; or they may be other elements such as grouping elements for grouping other widgets, for example a form widget and a logical widget.

The skeleton system 48 as shown in previous drawings operates by a detailed set of rules. (These rules are set forth and described both in the software code and in the documentation for users of the invention). For a given interactive-form application, the definition created by the application of these rules is the ‘skeleton definition’ (or ‘skeleton’ for short) and is embodied in JavaScript object literal code. The skeleton definition sets forth the appearance and structure of an interactive form as it appears in the web browser. Using the skeleton system 48, various types of widgets 52 (as defined in the available GUI API provided by the present invention) can be placed in an interactive form 32 according to a design 114 created by a web designer. Widgets 52 can be placed anywhere, including inside one another, in the interactive form 32; all concomitant logic or programming work is taken care of automatically by the built-in software code of the invention. Widgets 52 grouped as children of, or as contained by, a parent widget may be either shown on the web browser screen, or else hidden, depending upon the data that the parent widget holds at any given time, and depending upon any special rules programmed into the Controller object.

The appearance, layout, content, and behavior of a widget or widgets may be modified depending upon the data that the parent widget holds at any given time during the course of the operation of the application, and depending upon any special rules programmed into the Controller object. The standard Controller object must be customized for each unique application. It may be custom programmed with said special rules in order to enable the application to perform any dynamic tasks during the course of the operation of the application that are not already completely provided for by the built-in code of the invention. As the Controller is aware, at all times, of the state of all widgets and may manipulate all widgets, the Controller is an effective container for such software code instructions. This design bestows a very high level of variability in terms of the kinds of software applications that may be built with the invention.

Widget 52a represents a widget with one child widget placed inside of it. Widgets 52b, 52c, and 52d respectively represent a widget with none, two, and three child widgets placed inside of them. Widget 52e represents a widget with three layers of nesting. An example of three levels of nesting is a form widget that is a first level, with a check box widget inside of it as a second level (for example, an initial question in a survey questionnaire), and then another check box widget as the third level (e.g., a dependent question in a survey questionnaire). Widget 52f represents a widget with one child widget, and is distinct from widget 52a.

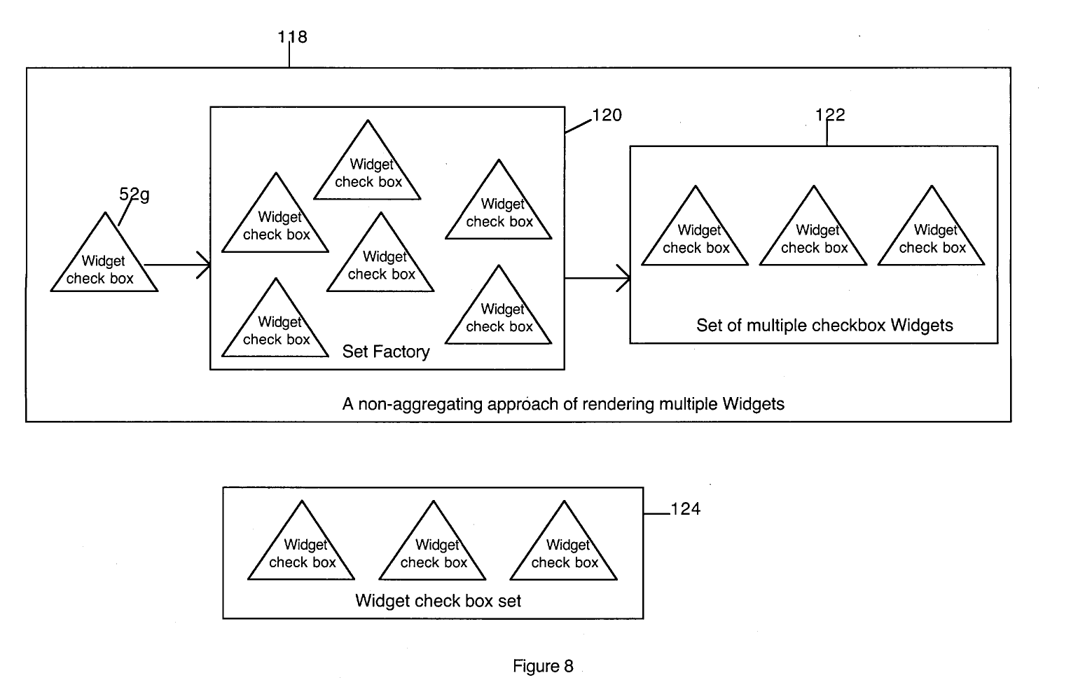

FIG. 8 illustrates how the present invention economizes on the total amount of required code, by implementing set architecture for widgets. In the drawing, box 118 represents a non-aggregating approach of rendering multiple widgets. As an example, a widget checkbox 52g must be placed inside a set factory 120 in order to produce a set of multiple check box widgets 122. Instead, with the present invention a widget checkbox set 124 is provided in order to save code.

Often in surveys and other interactive forms, input elements similar to each other (for example, a checkbox or text input box) are displayed together. Rather than having class definitions for widgets that represent individual checkboxes, and a separate concrete set class definition that arranges and aggregates these discrete widgets, code size has been reduced, parsing and interpretation time decreased, and clarity of purpose increased by implementing the ‘set’ architecture. In the software architecture of the present invention, the concrete objects that are displayable in sets are each defined in concrete classes that represent specific types of set widgets. Each of these concrete classes inherits its set-nature from a single abstract set class definition common to all of these concrete classes. Thus, wherever there has been an opportunity to aggregate what could have been separate widgets into one single widget, this aggregation has been done. The class definitions for sets of widgets, such as for a set of checkbox widgets, are of course capable of producing objects that can display a set of only one checkbox.

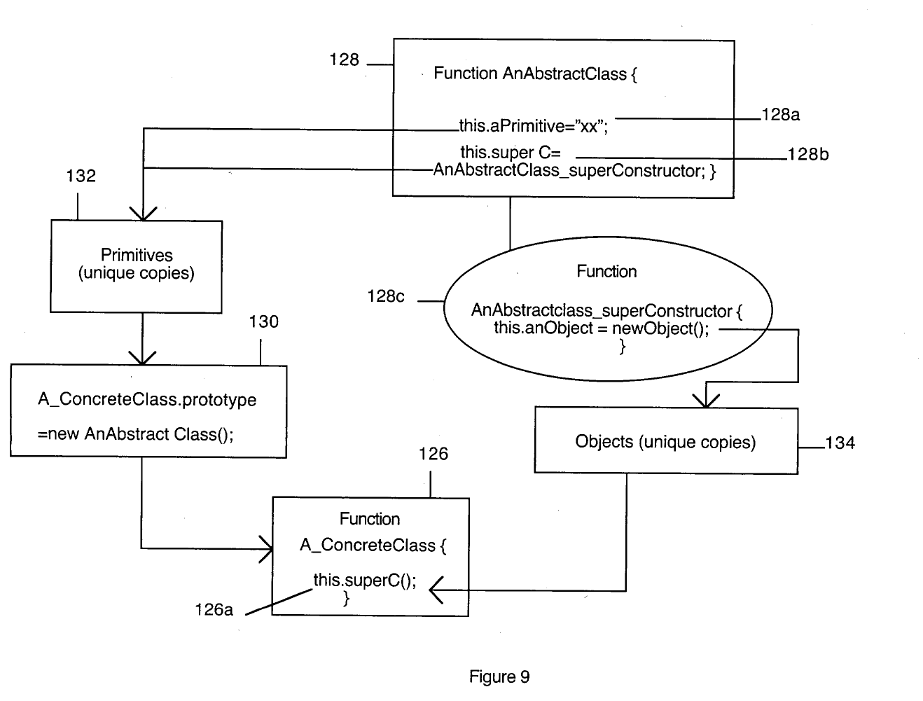

FIG. 9 illustrates class-based inheritance, wherein a concrete/base class definition (or, simply put, a ‘class’) ‘A_ConcreteClass’ 126 inherits or extends an abstract class ‘AnAbstractClass’ 128, such that class inheritance, a major feature of languages such as Java and C++, is realized. The essential feature of class inheritance is the inheritance of unique copies of all data values from the abstract class.

To achieve this inheritance, the prototype property of ‘A_ConcreteClass’ 126 is bound to ‘AnAbstractClass’ 128 by the statement ‘A_ConcreteClass.prototype=new AnAbstractClass( );’ 130. This statement exists in the global scope of the application software code and hence is executed only once, at the launching of the application. The binding that this statement creates allows ‘A_ConcreteClass’ 126 to inherit primitive properties from ‘AnAbstractClass’ 128. A statement ‘this.aPrimitive=“xx”;’ 128a represents the assignment of a literal value (enclosed in quotes) to an object property, ‘this.aPrimitive’. By the rules of the JavaScript language, this makes ‘this.aPrimitive’ a primitive object property, with a primitive value of “xx”. The object that the primitive is a property of is referred to by the keyword, ‘this’, as above. A statement ‘this.superC=AnAbstractClass_superConstructor’ 128b also represents the assignment of a literal value to a primitive property of an object. This is so because ‘AnAbstractClass_superConstructor’ 128b identifies a function that is defined in elsewhere in the software code as a function literal. As the identifier of this function literal, it represents the function literal as a whole. Object properties that hold only a single primitive value are often referred to in shorthand as ‘primitives.’

In JavaScript, the possible values of primitives include numbers, strings, Boolean values, and—very significantly—functions. Primitive values and object values (referred to as ‘objects’) are two types of represented values common in computer software languages. They are the two types of represented values in JavaScript; non-represented values are termed ‘literal’ values or ‘literals.’ Literal values are not subject to inheritance, except as they are represented in primitives or objects. Object values may contain primitive values, but not vice-versa.

All of the types of values that may be held by primitives may also be represented in object form by what is known to those skilled in the art as an ‘object wrapper,’ i.e., a wrapper around a simple primitive. However, it is the manner in which the types of values are defined in the software code that determines whether they are in fact primitives or objects. As discussed below, the difference in the treatment that JavaScript gives to primitives and to objects, in the matter of inheritance, is central.

In a nutshell, in the present invention ‘abstract’ classes are implemented as prototype properties of ‘inheriting’ classes. Since the ‘abstract’ classes are prototype properties, a special mechanism must exist to provide unique copies of objects to ‘inheriting’ classes. Prototype properties in JavaScript do not provide unique copies of objects by default. Rather, by default they share their properties of type Object (non-primitives) among all ‘inheriting’ classes, so that if a single inheriting class modifies a shared object property, it is modified for all other inheriting classes. By contrast, primitives are bestowed (effectively speaking) as unique copies upon inheriting classes. Each inheriting class gets its own copy of each inherited primitive. The present invention leverages the inheritance of primitives to attain the inheritance of unique copies of designated objects. Next, the mechanics of this leveraging is explained.

The statement ‘this.superC=AnAbstractClass_superConstructor;’ 128b, executed after the statement ‘A_ConcreteClass.prototype=new AnAbstractClass( );’ 130 is executed, causes ‘AnAbstractClass_superConstructor’ 128c to be a unique function property of ‘AnAbstractClass’ 128 (in OOP terminology, a ‘method’), because functions are primitive values in JavaScript. Thus the main function ‘AnAbstractClass_superConstructor’ 128c is accessible as a method of ‘AnAbstractClass’ 128, and as a method of all inheriting classes, via the identifier ‘this.superC’. Function properties in JavaScript are treated in the present invention's API as method properties of the class to which they are bound, following the design of the Java programming language. Because the ‘this’ scope of a given function property of a class is in fact that of the class itself, function properties in JavaScript when used as just described effectively simulate methods in a class-based language such as Java.

Nomenclature is applied to the naming of function properties (‘methods’), such that it is clear to what class the method belongs. In this example, ‘AnAbstractClass_superConstructor’ 128c clearly is a method of ‘AnAbstractClass’ 128. JavaScript itself does not enforce such a convention; but, in general, conventions that clarify code are known to those skilled in the art to be essential to industrial software development. Therefore, this convention represents an essential aspect of the invention.

Because ‘AnAbstractClass_superConstructor’ 128c is the value of a primitive property of ‘AnAbstractClass’ 128 (represented by ‘this.superC’ of item 128a), it may be invoked by the constructor of the concrete class ‘A_ConcreteClass’ 126. When so invoked, ‘AnAbstractClass_superConstructor’ 128c is treated by the JavaScript interpreter as a unique property of ‘A_ConcreteClass’ 126. (The function ‘A_ConcreteClass’ 126 serves as the class constructor for the class named ‘A_ConcreteClass’ 126.) When so invoked by the constructor of ‘A_ConcreteClass’ 126, ‘AnAbstractClass_superConstructor’ bestows unique copies of any objects it happens to create upon an object being created from ‘A_ConcreteClass’ 126. The statement, ‘this.superC( )’ 126a exists in the constructor of ‘A_ConcreteClass’ 126. When said constructor is invoked, the statement, ‘this.superC( )’ 126a is executed within the scope/context of said constructor. This causes the code inside the function identified by ‘AnAbstractClass_superConstructor’ 128c to be executed inside the scope/context of the object being constructed from ‘A_ConcreteClass’ 128. During this execution, the statement ‘this.anObject=new Object( );’ contained in item 128ccauses a new JavaScript object to be created and assigned to ‘this.anObject’. Since the scope that ‘this’ refers to is in the present example that of the object made from ‘A_ConcreteClass’ 126, ‘this.anObject’ becomes a new/unique object property of the object being instantiated by the constructor ‘A_ConcreteClass’ 126.

Boxes 132 and 134 represent the process of transferral of the respective values, primitive and object respectively, to the concrete class. (In actuality, object values defined in the abstract class are only transferred to objects instantiated from the concrete class, not to the concrete class itself. But the practical effect is the same either way, so this fact may be considered a detail.) These two boxes show the difference between the ways in which each unique copy of each type of value is inherited by the concrete class from the abstract class. The entire process of inheritance described above is identical for chains of inheritance, known to those skilled in the art as ‘prototype chains.’ In an inheritance chain, a concrete class inherits from a hierarchical chain of more than one abstract class.

Observing a strict and regular nomenclature and methodology is the best approach to carrying out such a simulation of true class inheritance in JavaScript. Thus, ‘this.superC( )’ in the API of the present invention is always the first statement inside any concrete class constructor that inherits from an abstract class. Again, JavaScript itself does not enforce such a convention; but, in general, conventions that clarify code are known to those skilled in the art to be essential to industrial software development. Therefore, this convention represents an essential aspect of the invention.

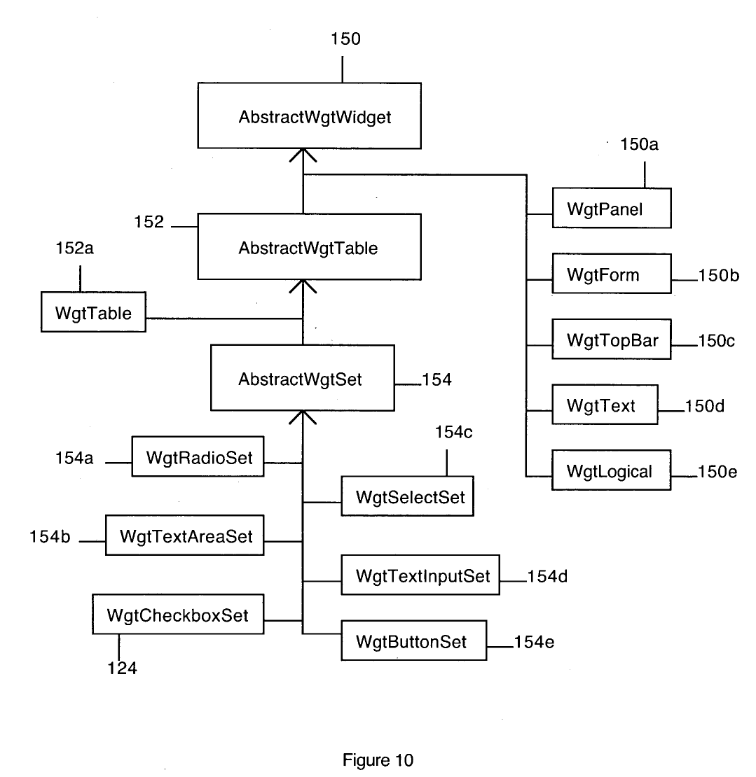

FIG. 10 illustrates inheritance as implemented in the present invention. In the drawing, AbstractWgtWidget/abstract widget class 150 is an abstract widget class that all concrete widgets and all other abstract widget classes inherit from. It contains methods and properties common to all widgets. All widgets have a ‘superConstructor’ method in addition to the main constructor. The two constructors are used together to effectively simulate class-based inheritance (such as that used by Java and C++) in JavaScript as described in FIG. 9, The main constructor assigns primitive object values, including methods; while the superConstructor assigns object values of type object.

With the present invention, concrete set widgets 124 and 154a through 154d inherit from an abstract set widget 154, which itself inherits from an abstract table widget 152. The abstract table widget 152 inherits from an abstract widget class/AbstractWgtWidget 150.

WgtPanel/panel widget 150a is a layout container widget. This widget manages what is known in the art as the HTML ‘div’ for standard browsers, or as the ‘layer’ for Netscape 4.x. The panel widget 150a is used in all surveys and other interactive forms that are designed to run across even primitive browsers such as Netscape 4.x, to hold WgtForm/form widget 150b as it serves a survey or other interactive form. For primitive browsers such as Netscape 4.x, and also for buggy browsers such as Netscape 6 and 7, it accomplishes the invaluable purpose of being a completely refreshable container. In other words, old HTML can be erased from it, and fresh HTML written into it, in order to force the display to appear as desired. Therefore, all dynamic content is placed inside the panel widget 150a, so that the survey or other interactive form will work on Netscape 4.x, Netscape 6.x, and Netscape 7.x (no Netscape 5.x was ever released). This placement is achieved by making the panel widget 150a the parent of all dynamic widgets, as defined in the skeleton object 48. Thus for primitive and buggy browsers, whenever the display on the screen of the form elements changes, all content in the panel is completely refreshed to show the updated state. By contrast, for browsers that function correctly, only the individual form elements that change are refreshed, not the entire set of form elements.

The form widget 150b defines a set of data input elements whose data will be sent to the webserver computer when the ‘submit’ method is called on what is known in the art as the DOM form element. The form widget 150b manages the DOM form element; all widgets manage one or more HTML/DOM elements.

Significantly, the HTML/DOM interactive-form element has no visual consequences, except for one on Netscape 4.x that is bug-related. When rendering an HTML/DOM interactive-form element, Netscape 4.x causes a single extra line break at the top of the form that is incorrect, or that at least is not compliant with industry standards.

WgtTopBar/top bar widget 150c optionally displays the title of the interactive form, a disclaimer from the programmer or software-engineering firm that produced the survey or other interactive form, and an e-mail link to that programmer or firm; and it always displays what is recognized in the art as a help button. The top-bar widget 150c manages all help-window functionality.

WgtText/text widget 150d provides necessary facilities for displaying properly indented text, optionally either very simply, or else processed to appear correctly in the context of a relatively positioned page layout.

WgtLogical/logical widget 150e has no corresponding innate HTML/DOM element or set of elements. However, it can manage the HTML elements of its child widgets, by sending commands to those child widgets. WgtLogical serves the sole purpose of grouping various sets of widgets, at a single point in the containment structure of a skeleton. It makes implementing application branching logic of the ‘if respondent's answer is “YES” then show this screen, if respondent's answer is “NO” then show that screen’ variety convenient for the web designer.

Further in FIG. 10, AbstractWgtTable/abstract table widget 152 contains all the functionality for a given widget, be it a set widget or a discrete widget, to render itself as a table. WgtTable/table widget 152a inherits from the abstract table widget 152. It is used when a single table containing a single table data cell is desired to contain child contents, and can later be expanded to produce complex table-based screen/web-page layouts. Wrapping an element in a table allows for correct ‘flowed’ (i.e., relative) positioning, as described in FIG. 4.

As stated above, the AbstractWgtSet/abstract set widget 154 is the abstract class that all concrete set widgets inherit from. A set widget may contain one or more HTML elements. For example, a set widget may contain one or more checkboxes, as shown in FIG. 8 as the widget check box set 124. The abstract set widget 154 contains methods and properties that are common to all set widgets, but are not related to the function of rendering an HTML table. WgtRadioSet 154a is the set widget that contains one or more sets of radio buttons. WgtTextAreaSet 154b is the set widget that contains one or more text areas. WgtSelectSet 154c is the set widget that contains one or more drop-down select lists. WgtTextlnput 154d is the set widget that contains one or more text input boxes. WgtButtonSet 154e is the set widget that contains one or more standard buttons.

Advantages

From the description above, a number of advantages of the present invention become evident.

An important outcome of the client-side functionality of the present invention is that the amount and quality of information collected is maximized. Conventionally, interactive-form questions/items are presented to a respondent in one of two ways: The first way is that questions/items are shown as a series of screen redrawings, so that the respondent is unable to determine how many questions he or she will be answering in total unless a separate meter is provided to inform the respondent of this. The second way is that many questions are shown at once.

With the present invention, a respondent initially sees only a limited and finite number of questions/items; dependent questions/items are revealed instantaneously as the respondent enters the information for a chosen question/item. Thus the respondent does not have to wait for each new page of the interactive form to be updated by the webserver computer. Therefore, the respondent's task of responding to interactive-form questions/items becomes faster and easier, with the result that more information is collected. In addition, with the present invention, a natural byproduct of the telescoping nature of the presented interactive-form questions/items is that the interactive form is much more resistant to ‘early submission’ than are conventional interactive forms.

This result is true because the outermost scope of questions is presented initially to a respondent. Therefore, any basic points are covered from the outset. Furthermore, should a respondent change his or her mind about a response and its dependent questions, with the present invention he or she may back up immediately without affecting the rest of the form. Thus, the present invention allows for great flexibility that is missing in conventional web-based interactive forms.

The interactive-form software of the present invention is able to produce a wide variety of interactive forms, while at the same time interactive forms are encapsulated in a short format. In standard interactive forms these two capabilities conflict with one another, but the software engineering of the present invention allows for both of these capabilities to coexist. Conventional interactive-form-software systems, while able to produce a variety of interactive forms, also require large amounts of custom-built code, thereby lengthening the amount of time needed to download the interactive forms and increasing the cost of building the code to do the job.

Even a few fractions of a second saved is a major human factor in the success of any software application on the Internet.² One manner in which the present invention reduces the time needed to download and interact with interactive form applications is by employing full class inheritance in JavaScript, implemented wherever practical in the software architecture. This results in a much smaller code size, leaving less to download. It also results in much more rapid execution of the JavaScript software code, allowing the respondent to begin interacting with the application (once it has downloaded to the respondent's computer) earlier than would otherwise be the case.

The present invention achieves its decisive, central improvement over standard approaches (in terms of the time needed to download the interactive form applications, the ease of use they provide for the respondent, their quick responsiveness to respondent input, and the lower demands that they place on the webserver computer) by making use of the vast reserve of computing power that resides within every respondent's client computer, be it a desktop or a portable or wireless model. Relying on frequent streams of HTML code from the webserver computer, to redraw the screen, is the equivalent of repeatedly bulldozing a garden to get rid of some weeds, and then repeatedly hiring a garden crew to replant it—when some well-targeted weeding or cultivation would adequately take care of the problem.

The bulldozer approach is also costly in terms of the web-server-computer processing time required to repeatedly concatenate the character strings comprising the HTML code, and in terms of the network bandwidth absorbed by the streaming HTML. And it is disruptive to the respondent's focus on the interactive form, because of the waiting time between mouse clicks, and the screen flicker that occurs when a web page is totally updated. JavaScript logic is now commonly employed to dynamically update certain oft-refreshed segments of the screen. However, when applied within the context of a suitable software architecture, it is easily capable of managing the entire application's graphical respondent interface, along with significant application-specific business logic, and it also can handle persistent or regular HTTP connections easily—and across different platforms.

An additional advantage of the present invention is that it includes elements that make it work correctly for the browsers used by 99.5% of all respondents of the web, according to recent extensive field tests. These elements are:
a) The reliance on only those software languages that are standard and that are ubiquitous on the Internet.
b) The compactness of the invention's code.
c) The invention's ultra-streamlined and efficient widgets and skeleton system,
d) The invention's employment of a flowed layout instead of absolute-positioning layout, although the use of absolute positioning is not prevented.

Further advantages are:
1) The invention's parent-child widget system, as it is implemented in a code-length-reducing manner.
2) The invention's use of a very code-length-efficient method that defines the web application user interface and data validation.
3) The invention's front-end API (Application Program Interface), although novel in itself, which fits seamlessly into current industry-standard webserver computer-side implementations such as Java Servlets.
4) The invention's defined JavaScript widget object parent-child containment system, which produces a dynamic data-centric web application that works even for primitive or antique web browsers, while not restricting performance on advanced web browsers.
5) The selection of a certain restricted set of supported widget objects, restricted to those that are needed to serve e-business practically and effectively. Code-size and production expense may be cut, when necessary, by the exclusion of such deluxe features as draggable screen objects, HTML animations, and persistent HTTP connections. Such features are essential for interactive gaming over the Internet, but they are not essential for e-business; and they increase code size enough to reduce the accessibility and utility of the web application for the large majority of possible respondents who still rely on dial-up Internet connections. Code size and production expense have also been reduced by bundling related functionality into a single widget wherever possible. For example, the ‘TopBar’ widget handles the title, the byline, and Help-window-opening button of a web application all within one widget.
   Conclusion, Ramifications, and Scope

Accordingly, the reader will see that the interactive-form software of the present invention increases the amount and the quality of information collected, and is able to produce a wide variety of interactive forms; while, at the same time, interactive forms are encapsulated within a short format, which reduces the amount of time needed to download an interactive form. Additionally, the present invention is improved over standard approaches by making use of the vast reserve of computing power that resides within every respondent's computer. Furthermore, the present invention has supplementary, integrated advantages:
It provides a code-length-reducing parent-child widget system.
It provides a code-length-efficient method that defines the web application user interface and data validation.
It provides a novel front-end API (Application Program Interface) that fits seamlessly into current industry-standard webserver computer-side implementations such as Java Servlets.
It provides Java and JavaScript classes for communication between web browser and web server, along lines known to those skilled in the art and described thoroughly in the book JavaScript Objects.
It provides a defined HTML element containment system that produces a web application that works even for primitive browsers.
It permits smaller code-size and lower production expense by selecting a certain restricted set of widget objects, including only those which are needed to serve e-business practically and effectively.
It provides for bundling related functionality into a single widget wherever possible, a design feature that cuts down code size and production expense.

Although the descriptions above contain much specificity, these should not be construed as limiting the scope of the invention, but merely as providing illustrations of some of the presently preferred embodiments of this invention.

Thus the scope of the invention should be determined by the appended claims and their legal equivalents, rather than by the examples given.

### DISCLOSURE OF THE INVENTION

Date of Conception: May 2002.

Date of Reduction to Practice: Sep. 16, 2002

Publication, if Any: Not applicable.

Use Outside the Company, if Any: February 2003.

Commercialization, if Any: February 2003.

References

1. Re: % of Internet users relying on dial-up connections. (Referenced on page 5.)

a) ‘The Basics of Webserver Performance Testing,’ Erik Paessler. Available on the Web at
http://www.paessler.com/support/e43/index_eng.html

b) And see also ‘Size Really Does Matter,’ Janastar Marketing Group. Available on the Web at
http://www.janastar.com/size_really_does_matter.htm

2. Re: Time decay of Internet user attention with delay. (Referenced on page 36.)

a) ‘Browser News: Stats,’ about.com. Available on the Web at
http://webdesign.about.com/gi/dynamic/offsite.htm?site=http%3A%2F%2Fwww. upsdell.com%2FBrowserNews%2Fstat.htm
   (This is all one URL, even though it does not all fit on one line here.)

b) And see also ‘Stuck With Old Browsers Until 2003,’ Jakob Nielsen, Apr. 18, 1999. Available on the Web at
http://www.useit.com/alertbox/990418.html
1. Nakhimovsky, Alexander, and Myers, Tom, JavaScript Objects, Birmingham, U.K.: Wrox Press, 1998, ISBN 1-861001-89-4 Web Address: http://www.wrox.com/books/1861001894.htm
   Appendix A: Sequence Listing or Program

Two (2) compact discs are submitted (with a Transmittal Letter, as required), and are identical.

List of Files;
dental0/index.html, 59237 bytes, created on May 14 11:19 2003
dental0/index.html.gz, 14556 bytes, created on May 14 11:18 2003
dental0/static/canvas.css, 455 bytes, created on Jan. 1 12:40 2003
dental0/static/check_no_javascript.html, 1513 bytes, created on May 14 11:13 2003
dental0/static/help.html, 2529 bytes, created on Apr. 4 17:22 2003
phraseologic/phraseologic/index.html, 73951 bytes, created on May 14 03:22 2003
phraseologic/phraseologic/index.html.gz, 19212 bytes, created on May 14 03:21 2003
phraseologic/phraseologic/static/canvas.css, 230 bytes, created on May 13 13:35 2003
phraseologic/phraseologic/static/check_no_javascript.html, 1513 bytes, created on May 14 11:13 2003
phraseologic/phraseologic/static/help.html, 3084 bytes, created on May 3 16:59 2003
phraseologic/phraseologic/static/background_tile_beige_small.jpg, 2506 bytes, created May 3 16:59 2003
phraseologic/phraseologic_query/index.html, 80918 bytes, created on May 14 10:22 2003
phraseologic/phraseologic_query/index.html.gz, 20265 bytes, created on May 14 10:09 2003
phraseologic/phraseologic_query/static/canvas.css, 231 bytes, created on May 15 2002
phraseologic/phraseologic_query/static/check_nojavascript.html, 1513 bytes, created on May 14 11:13 2003
phraseologic/phraseologic_query/static/test_server_whiteboard.html, 3579 bytes, created on May 14 10:16 2003
phraseologic/phraseologic_query/static/help.html, 16695 bytes, created on May 15 2002
phraseologic/phraseologic_query/static/background_tile_beige_small.jpg, 2506 bytes, created May 3 16:59 2003

1. A computer-implemented method for presenting survey questionnaires and other interactive forms, comprising: a plurality of survey/interactive-form questions/items and at least one dependent question/item; presenting at least one of the survey/interactive-form questions/items to a respondent; receiving response data from the respondent; and instantly presenting at least one of the dependent questions/items to the respondent.

2. The method of claim 1, wherein the survey/interactive form questions/items comprise initial questions/items and dependent questions/items.

3. The method of claim 2, wherein the initial questions are presented all-at-once to the respondent, and the method further comprises presenting at least one of the dependent questions to the respondent instantly, if the respondent chooses the initial question.

4. The method of claim 1, wherein the method is performed in a distributed computer system, comprising a webserver computer which includes a database, and wherein the interactive form (such as a survey questionnaire) is received via a browser at a client computer, and the method further comprises transmitting the survey/interactive form questions/items from the webserver computer to the client computer via the Internet.

5. The method of claim 4, further comprising storing the response data in the database.

6. The method of claim 5, further comprising storing interactive-form data from additional respondents in said database.

7. A software architecture system comprising:
a) A Controller object, implemented in JavaScript, for controlling the behavior displayed by the interactive form (such as a survey questionnaire) as it runs on the browser, and also optionally for communicating with the webserver computer via messages that it may send and receive.
b) A static data structure, implemented in JavaScript object literal notation as the Skeleton object, for controlling what appearance and content the interactive form (such as a survey questionnaire) displays on the browser, and defining what data validation routines are to be applied to respondent-supplied information.
c) A Model object for handling execution of the data validation routines.
d) A collection of widget objects for managing elements defined by hypertext markup language (HTML) and/or the Document Object Model (DOM).

8. The method of claim 7, further comprising:
a) The widget objects displaying at least one of visible, audible, tactile, and/or olfactory content on the browser to the respondent.
b) The widget objects receiving input from the respondent and updating at least one of what the respondent sees and/or hears, and perhaps also in the future feels and/or smells.
c) The widget objects notifying the controller of any input from the respondent.

9. The method of claim 7, further comprising the widget objects sensing the response data from the respondent and alerting the Controller object for review, and the Controller object checking with the Model object to perform any required validations of the response data from the respondent, before the Controller object sends the response information back to the webserver computer.

10. The method of claim 7, wherein all objects that directly affect the content and appearance of the screen are widgets—technically, objects of type Widget.

11. The method of claim 7, wherein the Controller object
a) Creates a plurality of widget objects.
b) Directs at least one of the widget objects to draw itself.

12. The method of claim 11, wherein the widget object contains a reference to a parent widget, if any and a reference to a child widget, if any, and the method further optionally comprises a plurality of widgets including none or more child widgets, whereby the references to the parent widget and the child widgets thus maintain a tree structure of widgets.

13. The method of claim 11, wherein the widget that draws itself also commands those of its child widgets that are currently switched to be able to draw themselves to also draw themselves, and so on down a hierarchy, until child widgets are reached that have no children.

14. The method of claim 13 wherein the inclusion of references contained in a given widget and referring from the given widget to optional child widgets and an optional parent widget provides for a graphical respondent interface definition, whereby the need for a separate data structure outside of the widget objects themselves to keep track of and describe the widget hierarchy is obviated, and whereby extreme compactness and clarity of code is reached. The compactness and clarity of the code result in an improved experience for the respondent by virtue of reduced waiting time, and in increased usability for software developers using the system of claim 7. It remains possible for the Controller object to modify the widgets at will, regardless of the configuration defined at download time by the Skeleton object; thus, customized coding may still be used to implement specific different behavior.

15. The method of claim 13, wherein all widgets are equipped with a ‘getHTML’ method and a ‘getChildrensHTML’ method by virtue of the fact that they all inherit from a single widget class that defines the minimum functionality for said methods, and wherein each ‘getHTML’ method of a given widget is programmed to invoke a ‘getChildrensHTML’ method of the given widget which in turn invokes the ‘getHTML’ method of each child widget of the given widget, whereupon each ‘getHTML’ method of each child widget invokes the ‘getChildrensHTML’ method of each child widget, and so on forming what is recognized to those skilled in the art as a recursive control structure.

16. The method of claim 15, wherein the recursive control structure operates primarily with only two methods, the ‘getHTML’ method and the ‘getChildrensHTML’ method, and is directed entirely and inherently by the very same references that define the parent-child widget hierarchy, whereby considerable code is saved via the recursive control structure over a comparable iterative approach, and whereby the amount of excess code avoided results in less waiting time for the end respondent, giving an improved respondent experience and thus an improved application performance.

17. The method of claim 7, wherein the static data structure of the Skeleton object allows widgets to be placed anywhere and inside one another within an interactive form (such as a survey questionnaire), whereby all concomitant logic and/or programming work is taken care of automatically.

18. The method of claim 7, wherein the widgets are implemented via a set-architecture means for saving code size, decreasing parse time, and increasing clarity of purpose.

19. The method of claim 7, wherein a main constructor and a superconstructor are provided in order to simulate class-based inheritance in JavaScript.
